(19) United States
(12) Patent Application Publication
(10) Pub. No.: US 2022/0388630 A1
(43) Pub. Date: Dec. 8, 2022

(54) SPEECH RECOGNITION METHODS AND SYSTEMS WITH CONTEXTUAL KEYWORD MAPPING

(71) Applicant: HONEYWELL INTERNATIONAL INC., Charlotte, NC (US)

(72) Inventors: Hariharan Saptharishi, Madurai (IN); Gobinathan Baladhandapani, Madurai (IN); Sivakumar Kanagarajan, Bangalore (IN); Amrun Raja Rahim, Madurai (IN)

(73) Assignee: HONEYWELL INTERNATIONAL INC., Charlotte, NC (US)

(21) Appl. No.: 17/443,275

(22) Filed: Jul. 23, 2021

(30) Foreign Application Priority Data
Jun. 7, 2021 (IN) 202111025170

(51) Int. Cl. B64C 13/02; G08G 5/00; G10L 15/22; G10L 15/26

(52) U.S. Cl. CPC B64C 13/02; G08G 5/0095; G10L 15/22; G10L 15/26; G10L 2015/223

(57) ABSTRACT

Methods and systems are provided for assisting operation of a vehicle using speech recognition. One method involves automatically identifying a parameter value for an operational subject based at least in part on a preceding audio communication with respect to the vehicle and thereafter recognizing an audio input as an input command, determining a second operational subject associated with the input command, and automatically commanding a vehicle system to implement the parameter value for the operational subject when the second operational subject maps or otherwise corresponds to the operational subject associated with the parameter value. In this regard, the second operational subject may be conveyed by a user enunciating placeholder terminology that maps to the operational subject as part of the input command.

### CROSS REFERENCE TO RELATED APPLICATION

This application claims priority to Indian Provisional Patent Application No. 202111025170, filed Jun. 7, 2021, the entire content of which is incorporated by reference herein.

### TECHNICAL FIELD

The subject matter described herein relates generally to vehicle systems, and more particularly, embodiments of the subject matter relate to contextual speech recognition for interfacing with aircraft systems and related cockpit displays using air traffic control communications.

### BACKGROUND

Air traffic control typically involves voice communications between air traffic control and a pilot or crewmember onboard the various aircrafts within a controlled airspace. For example, an air traffic controller (ATC) may communicate an instruction or a request for pilot action by a particular aircraft using a call sign assigned to that aircraft, with a pilot or crewmember onboard that aircraft acknowledging the request (e.g., by reading back the received information) in a separate communication that also includes the call sign. As a result, the ATC can determine that the correct aircraft has acknowledged the request, that the request was correctly understood, what the pilot intends to do, etc.

Modern flight deck displays (or cockpit displays) are utilized to provide a number of different displays from which the user can obtain information or perform functions related to, for example, navigation, flight planning, guidance and navigation, and performance management. Modern displays also allow a pilot to input information, such as, navigational clearances or commands issued by ATC. However, input of an incomplete and/or incorrect clearance can be consequential and antithetical to maintaining aircraft control. Accordingly, it is desirable to provide aircraft systems and methods that facilitate inputting ATC clearances or commands with improved accuracy. Other desirable features and characteristics of the methods and systems will become apparent from the subsequent detailed description and the appended claims, taken in conjunction with the accompanying drawings and the preceding background.

### BRIEF SUMMARY

Methods and systems are provided for assisting operation of a vehicle, such as an aircraft, using speech recognition and related analysis of communications with respect to the vehicle. One method involves automatically identifying a parameter value for an operational subject based at least in part on an audio communication with respect to the vehicle, recognizing a received audio input as an input command with respect to the vehicle, determining a second operational subject associated with the input command, and automatically commanding a vehicle system associated with the operational subject to implement the parameter value identified from the audio communication when the second operational subject corresponds to the operational subject.

In another embodiment, a computer-readable medium having computer-executable instructions stored thereon is provided. The computer-executable instructions, when executed by a processing system, cause the processing system to automatically identify a parameter value for an operational subject based at least in part on a preceding audio communication with respect to a vehicle prior to receiving voice command audio input, recognize the voice command audio input as an input command including placeholder terminology, and automatically command a vehicle system to implement the input command utilizing the parameter value when the placeholder terminology corresponds to the operational subject.

In another embodiment, a system is provided that includes a communications system to receive an audio communication with respect to a vehicle, an audio input device receive input voice command audio, and a processing system coupled to the communications system and the audio input device. The processing system is configurable to automatically identify a parameter value for an operational subject based at least in part on the audio communication prior to receiving the input voice command audio, recognize the input voice command audio as an input command including placeholder terminology, and automatically command a vehicle system to implement the input command using the parameter value when the placeholder terminology corresponds to the operational subject.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

Embodiments of the subject matter will hereinafter be described in conjunction with the following drawing figures, wherein like numerals denote like elements, and:

FIG. 1 is a block diagram illustrating a system suitable for use with a vehicle such as an aircraft in accordance with one or more exemplary embodiments;

FIG. 2 is a block diagram illustrating a contextual speech recognition system suitable for use with the aircraft system of FIG. 1 in accordance with one or more exemplary embodiments; and

FIG. 3 is a flow diagram of a contextual mapping process suitable for implementation by the contextual speech recognition system of FIG. 2 in the aircraft system of FIG. 1 in one or more exemplary embodiments.

### DETAILED DESCRIPTION

The following detailed description is merely exemplary in nature and is not intended to limit the subject matter of the application and uses thereof. Furthermore, there is no intention to be bound by any theory presented in the preceding background, brief summary, or the following detailed description.

Embodiments of the subject matter described herein generally relate to systems and methods that facilitate a vehicle operator providing an audio input to one or more displays or onboard systems using a contextual speech recognition graph that is influenced by clearance communications associated with different vehicles operating within a commonly controlled area. For purposes of explanation, the subject matter is primarily described herein in the context of aircraft operating in a controlled airspace; however, the subject matter described herein is not necessarily limited to aircraft or avionic environments, and in alternative embodiments, may be implemented in an equivalent manner for ground operations, marine operations, or otherwise in the context of other types of vehicles and travel spaces.

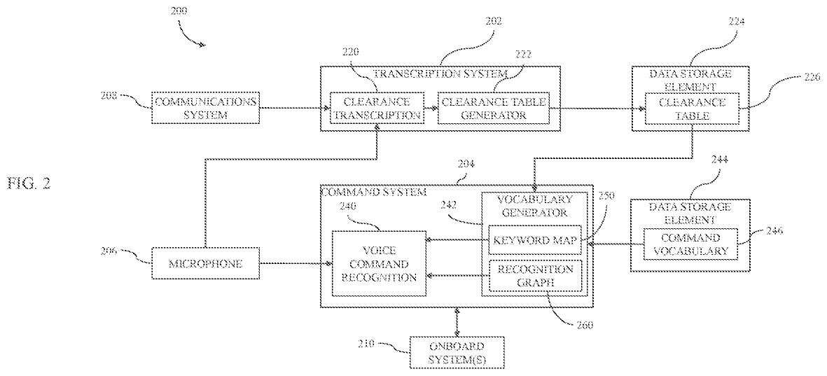

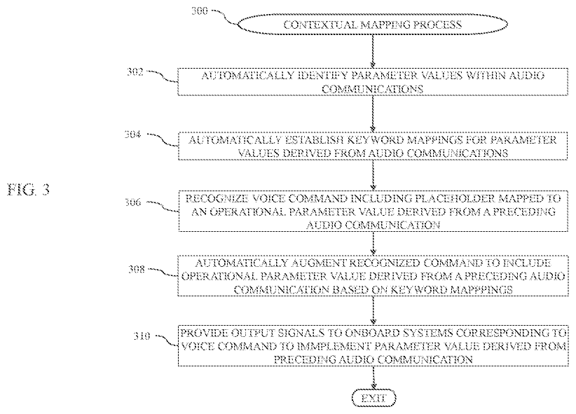

As described in greater detail below primarily in the context of FIGS. 2-3, audio communications received at the aircraft are parsed and analyzed to automatically identify defined or assigned parameter values for different operational subjects or entities that are specified within the audio communications. For example, natural language processing or similar artificial intelligence (AI) techniques may be applied to the audio communications (or transcriptions thereof) to ascertain the intent of a respective audio communication and identify the operational subjects or entities to which the respective audio communication pertains, such as, a runway, a taxiway, a waypoint, a heading, an altitude, a flight level, a communications radio or another avionics system or setting, an aircraft action (e.g., landing, takeoff, pushback, hold, or the like) and/or the like. The audio communication (or transcription thereof) may then be analyzed to identify a parameter value that is defined, assigned, or otherwise associated with the operational subject, such as, for example, a runway identifier, a taxiway identifier, a waypoint identifier, a heading angle, an altitude value, a radio channel frequency, and/or the like.

When an operational parameter value assigned to or defined for an operational subject is identified within an audio communication, an entry in a keyword mapping table is automatically created to establish an association or mapping between the operational parameter value and one or more words, terms and/or phrases that may be utilized to refer to the operational subject to which that parameter value pertains. Thereafter, when a received audio input command is recognized that includes a reference to the operational subject that matches or otherwise corresponds to the operational subject of the preceding audio communication from which the operational parameter value was derived, the keyword mapping table is utilized to implement input command using the identified operational parameter value. For example, in some embodiments, the keyword mapping table may be utilized to augment the recognized audio input command by substituting the identified operational parameter value for the corresponding words, terms and/or phrases that were previously used to reference the operational subject. In yet other embodiments, the language model utilized by the speech recognition engine may be augmented or modified to include potential voice commands that utilize the different words, terms and/or phrases that may be utilized to refer to the operational subject in the input voice command rather than requiring the user to specify the parameter value, with the keyword mapping table being utilized to retrospectively interchange the oral reference to the operational subject with the previously identified parameter value.

For example, in one or more implementations, a speech recognition engine is implemented using two components, an acoustic model and a language model, where the language model is implemented as a finite state graph configurable to function as or otherwise support a finite state transducer, where the acoustic scores from the acoustic model are utilized to compute probabilities for the different paths of the finite state graph, with the highest probability path being recognized as the desired user input which is output by the speech recognition engine to an onboard system. In this regard, the keyword mapping table may be utilized to augment the finite state graph that includes different references to the operational subject, thereby accommodating a shorter, more concise voice command that can be subsequently mapped to a particular operational parameter value rather than requiring the voice command contain the entire sequence of numbers, letters and/or other symbols to designate the operational parameter value. Thus, a contextually augmented speech recognition graph may be utilized to quickly and accurately recognize the received audio input as designating a previously defined or previously assigned operational parameter value for a particular operational subject without delays or potential errors that could otherwise be associated with requiring longer voice commands that contain the entire sequence of numbers, letters and/or symbols to spell out the parameter value.

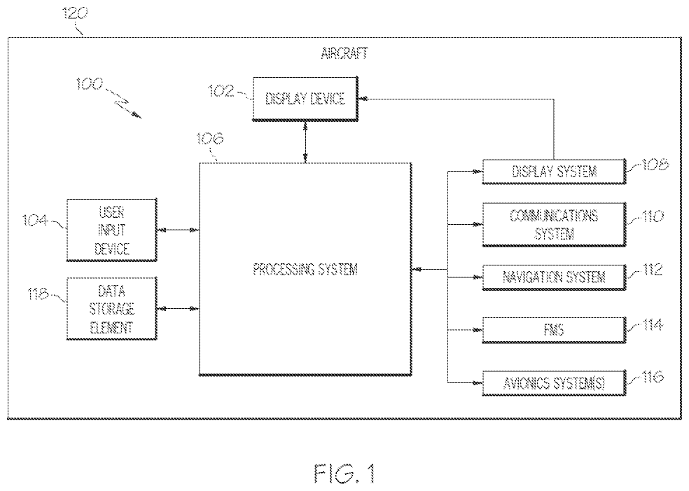

FIG. 1 depicts an exemplary embodiment of a system 100 which may be utilized with a vehicle, such as an aircraft 120. In an exemplary embodiment, the system 100 includes, without limitation, a display device 102, one or more user input devices 104, a processing system 106, a display system 108, a communications system 110, a navigation system 112, a flight management system (FMS) 114, one or more avionics systems 116, and a data storage element 118 suitably configured to support operation of the system 100, as described in greater detail below.

In exemplary embodiments, the display device 102 is realized as an electronic display capable of graphically displaying flight information or other data associated with operation of the aircraft 120 under control of the display system 108 and/or processing system 106. In this regard, the display device 102 is coupled to the display system 108 and the processing system 106, and the processing system 106 and the display system 108 are cooperatively configured to display, render, or otherwise convey one or more graphical representations or images associated with operation of the aircraft 120 on the display device 102. The user input device 104 is coupled to the processing system 106, and the user input device 104 and the processing system 106 are cooperatively configured to allow a user (e.g., a pilot, co-pilot, or crew member) to interact with the display device 102 and/or other elements of the system 100, as described in greater detail below. Depending on the embodiment, the user input device(s) 104 may be realized as a keypad, touchpad, keyboard, mouse, touch panel (or touchscreen), joystick, knob, line select key or another suitable device adapted to receive input from a user. In some exemplary embodiments, the user input device 104 includes or is realized as an audio input device, such as a microphone, audio transducer, audio sensor, or the like, that is adapted to allow a user to provide audio input to the system 100 in a “hands free” manner using speech recognition.

The processing system 106 generally represents the hardware, software, and/or firmware components configured to facilitate communications and/or interaction between the elements of the system 100 and perform additional tasks and/or functions to support operation of the system 100, as described in greater detail below. Depending on the embodiment, the processing system 106 may be implemented or realized with a general purpose processor, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. The processing system 106 may also be implemented as a combination of computing devices, e.g., a plurality of processing cores, a combination of a digital signal processor and a microprocessor, a plurality of microprocessors, one or more microprocessors in conjunction with a digital signal processor core, or any other such configuration. In practice, the processing system 106 includes processing logic that may be configured to carry out the functions, techniques, and processing tasks associated with the operation of the system 100, as described in greater detail below. Furthermore, the steps of a method or algorithm described in connection with the embodiments disclosed herein may be embodied directly in hardware, in firmware, in a software module executed by the processing system 106, or in any practical combination thereof. For example, in one or more embodiments, the processing system 106 includes or otherwise accesses a data storage element (or memory), which may be realized as any sort of non-transitory short or long term storage media capable of storing programming instructions for execution by the processing system 106. The code or other computer-executable programming instructions, when read and executed by the processing system 106, cause the processing system 106 to support or otherwise perform certain tasks, operations, functions, and/or processes described herein.

The display system 108 generally represents the hardware, software, and/or firmware components configured to control the display and/or rendering of one or more navigational maps and/or other displays pertaining to operation of the aircraft 120 and/or onboard systems 110, 112, 114, 116 on the display device 102. In this regard, the display system 108 may access or include one or more databases suitably configured to support operations of the display system 108, such as, for example, a terrain database, an obstacle database, a navigational database, a geopolitical database, a terminal airspace database, a special use airspace database, or other information for rendering and/or displaying navigational maps and/or other content on the display device 102.

In the illustrated embodiment, the aircraft system 100 includes a data storage element 118, which contains aircraft procedure information (or instrument procedure information) for a plurality of airports and maintains association between the aircraft procedure information and the corresponding airports. Depending on the embodiment, the data storage element 118 may be physically realized using RAM memory, ROM memory, flash memory, registers, a hard disk, or another suitable data storage medium known in the art or any suitable combination thereof. As used herein, aircraft procedure information should be understood as a set of operating parameters, constraints, or instructions associated with a particular aircraft action (e.g., approach, departure, arrival, climbing, and the like) that may be undertaken by the aircraft 120 at or in the vicinity of a particular airport. An airport should be understood as referring to any sort of location suitable for landing (or arrival) and/or takeoff (or departure) of an aircraft, such as, for example, airports, runways, landing strips, and other suitable landing and/or departure locations, and an aircraft action should be understood as referring to an approach (or landing), an arrival, a departure (or takeoff), an ascent, taxiing, or another aircraft action having associated aircraft procedure information. An airport may have one or more predefined aircraft procedures associated therewith, wherein the aircraft procedure information for each aircraft procedure at each respective airport are maintained by the data storage element 118 in association with one another.

Depending on the embodiment, the aircraft procedure information may be provided by or otherwise obtained from a governmental or regulatory organization, such as, for example, the Federal Aviation Administration in the United States. In an exemplary embodiment, the aircraft procedure information comprises instrument procedure information, such as instrument approach procedures, standard terminal arrival routes, instrument departure procedures, standard instrument departure routes, obstacle departure procedures, or the like, traditionally displayed on a published charts, such as Instrument Approach Procedure (IAP) charts, Standard Terminal Arrival (STAR) charts or Terminal Arrival Area (TAA) charts, Standard Instrument Departure (SID) routes, Departure Procedures (DP), terminal procedures, approach plates, and the like. In exemplary embodiments, the data storage element 118 maintains associations between prescribed operating parameters, constraints, and the like and respective navigational reference points (e.g., waypoints, positional fixes, radio ground stations (VORs, VORTACs, TACANs, and the like), distance measuring equipment, non-directional beacons, or the like) defining the aircraft procedure, such as, for example, altitude minima or maxima, minimum and/or maximum speed constraints, RTA constraints, and the like. In this regard, although the subject matter may be described in the context of a particular procedure for purpose of explanation, the subject matter is not intended to be limited to use with any particular type of aircraft procedure and may be implemented for other aircraft procedures in an equivalent manner.

Still referring to FIG. 1, in exemplary embodiments, the processing system 106 is coupled to the navigation system 112, which is configured to provide real-time navigational data and/or information regarding operation of the aircraft 120. The navigation system 112 may be realized as a global positioning system (GPS), inertial reference system (IRS), or a radio-based navigation system (e.g., VHF omni-directional radio range (VOR) or long range aid to navigation (LORAN)), and may include one or more navigational radios or other sensors suitably configured to support operation of the navigation system 112, as will be appreciated in the art. The navigation system 112 is capable of obtaining and/or determining the instantaneous position of the aircraft 120, that is, the current (or instantaneous) location of the aircraft 120 (e.g., the current latitude and longitude) and the current (or instantaneous) altitude or above ground level for the aircraft 120. The navigation system 112 is also capable of obtaining or otherwise determining the heading of the aircraft 120 (i.e., the direction the aircraft is traveling in relative to some reference). In the illustrated embodiment, the processing system 106 is also coupled to the communications system 110, which is configured to support communications to and/or from the aircraft 120. For example, the communications system 110 may support communications between the aircraft 120 and air traffic control or another suitable command center or ground location. In this regard, the communications system 110 may be realized using a radio communication system and/or another suitable data link system.

In exemplary embodiments, the processing system 106 is also coupled to the FMS 114, which is coupled to the navigation system 112, the communications system 110, and one or more additional avionics systems 116 to support navigation, flight planning, and other aircraft control functions in a conventional manner, as well as to provide real-time data and/or information regarding the operational status of the aircraft 120 to the processing system 106. Although FIG. 1 depicts a single avionics system 116, in practice, the system 100 and/or aircraft 120 will likely include numerous avionics systems for obtaining and/or providing real-time flight-related information that may be displayed on the display device 102 or otherwise provided to a user (e.g., a pilot, a co-pilot, or crew member). For example, practical embodiments of the system 100 and/or aircraft 120 will likely include one or more of the following avionics systems suitably configured to support operation of the aircraft 120: a weather system, an air traffic management system, a radar system, a traffic avoidance system, an autopilot system, an autothrust system, a flight control system, hydraulics systems, pneumatics systems, environmental systems, electrical systems, engine systems, trim systems, lighting systems, crew alerting systems, electronic checklist systems, an electronic flight bag and/or another suitable avionics system.

It should be understood that FIG. 1 is a simplified representation of the system 100 for purposes of explanation and ease of description, and FIG. 1 is not intended to limit the application or scope of the subject matter described herein in any way. It should be appreciated that although FIG. 1 shows the display device 102, the user input device 104, and the processing system 106 as being located onboard the aircraft 120 (e.g., in the cockpit), in practice, one or more of the display device 102, the user input device 104, and/or the processing system 106 may be located outside the aircraft 120 (e.g., on the ground as part of an air traffic control center or another command center) and communicatively coupled to the remaining elements of the system 100 (e.g., via a data link and/or communications system 110). Similarly, in some embodiments, the data storage element 118 may be located outside the aircraft 120 and communicatively coupled to the processing system 106 via a data link and/or communications system 110. Furthermore, practical embodiments of the system 100 and/or aircraft 120 will include numerous other devices and components for providing additional functions and features, as will be appreciated in the art. In this regard, it will be appreciated that although FIG. 1 shows a single display device 102, in practice, additional display devices may be present onboard the aircraft 120. Additionally, it should be noted that in other embodiments, features and/or functionality of processing system 106 described herein can be implemented by or otherwise integrated with the features and/or functionality provided by the FMS 114. In other words, some embodiments may integrate the processing system 106 with the FMS 114. In yet other embodiments, various aspects of the subject matter described herein may be implemented by or at an electronic flight bag (EFB) or similar electronic device that is communicatively coupled to the processing system 106 and/or the FMS 114.

FIG. 2 depicts an exemplary embodiment of a contextual speech recognition system 200 for recognizing speech or voice commands using keyword mapping derived from preceding audio communications. In one or more exemplary embodiments, the contextual speech recognition system 200 is implemented or otherwise provided onboard a vehicle, such as aircraft 120; however, in alternative embodiments, the contextual speech recognition system 200 may be implemented independent of any aircraft or vehicle, for example, at a ground location such as an air traffic control facility. That said, for purposes of explanation, the contextual speech recognition system 200 may be primarily described herein in the context of an implementation onboard an aircraft. The illustrated contextual speech recognition system 200 includes a transcription system 202, a command system 204, an audio input device 206 (or microphone) and one or more communications systems 208 (e.g., communications system 110). The output of the command system 204 is coupled to one or more onboard systems 210 (e.g., one or more avionics systems 108, 110, 112, 114, 116) to provide control signals or other indicia of a recognized control command or user input to the desired destination onboard system 210 (e.g., via an avionics bus or other communications medium) of the voice command for implementation or execution. It should be understood that FIG. 2 is a simplified representation of the contextual speech recognition system 200 for purposes of explanation and ease of description, and FIG. 2 is not intended to limit the application or scope of the subject matter described herein in any way.

The transcription system 202 generally represents the processing system or component of the contextual speech recognition system 200 that is coupled to the microphone 206 and communications system(s) 208 to receive or otherwise obtain clearance communications, analyze the audio content of the clearance communications, and transcribe the clearance communications, as described in greater detail below. The command system 204 generally represents the processing system or component of the contextual speech recognition system 200 that is coupled to the microphone 206 to receive or otherwise obtain voice commands, analyze the audio content of the voice commands, and output control signals to an appropriate onboard system 210 to effectuate the voice command, as described in greater detail below. In some embodiments, the transcription system 202 and the command system 204 are implemented separately using distinct hardware components, while in other embodiments, the features and/or functionality of the transcription system 202 and the command system 204 maybe integrated and implemented using a common processing system (e.g., processing system 106). In this regard, the transcription system 202 and the command system 204 may be implemented using any sort of hardware, firmware, circuitry and/or logic components or combination thereof. In one or more exemplary embodiments, the transcription system 202 and the command system 204 are implemented as parts of the processing system 106 onboard the aircraft 120 of FIG. 1.

The audio input device 206 generally represents any sort of microphone, audio transducer, audio sensor, or the like capable of receiving voice or speech input. In this regard, in one or more embodiments, the audio input device 206 is realized as a microphone (e.g., use input device 104) onboard the aircraft 120 to receive voice or speech annunciated by a pilot or other crewmember onboard the aircraft 120 inside the cockpit of the aircraft 120. The communications system(s) 208 (e.g., communications system 110) generally represent the avionics systems capable of receiving clearance communications from other external sources, such as, for example, other aircraft, an air traffic controller, or the like. Depending on the embodiment, the communications system(s) 208 could include one or more of a very high frequency (VHF) radio communications system, a controller-pilot data link communications (CPDLC) system, an aeronautical operational control (AOC) communications system, an aircraft communications addressing and reporting system (ACARS), and/or the like.

In exemplary embodiments, computer-executable programming instructions are executed by the processor, control module, or other hardware associated with the transcription system 202 and cause the transcription system 202 to generate, execute, or otherwise implement a clearance transcription application 220 capable of analyzing, parsing, or otherwise processing voice, speech, or other audio input received by the transcription system 202 to convert the received audio into a corresponding textual representation. In this regard, the clearance transcription application 220 may implement or otherwise support a speech recognition engine (or voice recognition engine) or other speech-to-text system. Accordingly, the transcription system 202 may also include various filters, analog-to-digital converters (ADCs), or the like, and the transcription system 202 may include or otherwise access a data storage element 224 (or memory) that stores a speech recognition vocabulary for use by the clearance transcription application 220 in converting audio inputs into transcribed textual representations. In one or more embodiments, the clearance transcription application 220 may also mark, tag, or otherwise associate a transcribed textual representation of a clearance communication with an identifier or other indicia of the source of the clearance communication (e.g., the onboard microphone 206, a radio communications system 208, or the like).

In exemplary embodiments, the computer-executable programming instructions executed by the transcription system 202 also cause the transcription system 202 to generate, execute, or otherwise implement a clearance table generation application 222 (or clearance table generator) that receives the transcribed textual clearance communications from the clearance transcription application 220 or receives clearance communications in textual form directly from a communications system 208 (e.g., a CPDLC system). The clearance table generator 222 parses or otherwise analyzes the textual representation of the received clearance communications and generates corresponding clearance communication entries in a table 226 in the memory 224. In this regard, the clearance table 226 maintains all of the clearance communications received by the transcription system 202 from either the onboard microphone 206 or an onboard communications system 208.

In exemplary embodiments, for each clearance communication received by the clearance table generator 222, the clearance table generator 222 parses or otherwise analyzes the textual content of the clearance communication using natural language processing and attempts to extract or otherwise identify, if present, one or more of an identifier contained within the clearance communication (e.g., a flight identifier, call sign, or the like), an operational subject of the clearance communication (e.g., a runway, a taxiway, a waypoint, a heading, an altitude, a flight level, or the like), an operational parameter value associated with the operational subject in the clearance communication (e.g., the runway identifier, taxiway identifier, waypoint identifier, heading angle, altitude value, or the like), and/or an action associated with the clearance communication (e.g., landing, takeoff, pushback, hold, or the like). The clearance table generator 222 also identifies the radio frequency or communications channel associated with the clearance communication and attempts to identify or otherwise determine the source of the clearance communication. The clearance table generator 222 then creates or otherwise generates an entry in the clearance table 226 that maintains an association between the textual content of the clearance communication and the identified fields associated with the clearance communication. Additionally, the clearance table generator 222 may analyze the new clearance communication entry relative to existing clearance communication entries in the clearance table 226 to identify or otherwise determine a conversational context to be assigned to the new clearance communication entry.

Still referring to FIG. 2, the processor, control module, or other hardware associated with the command system 204 executes computer-executable programming instructions that cause the command system 204 to generate, execute, or otherwise implement a voice command recognition application 240 capable of analyzing, parsing, or otherwise processing voice, speech, or other audio user input received by the command system 204 via the microphone 206 to convert the received audio into a corresponding command intended for a particular destination output system 210. In this regard, command recognition application 240 implements or otherwise supports a speech recognition engine (or voice recognition engine) or other speech-to-text system. In exemplary embodiments, the recognition engine implemented by the command recognition application 240 is realized using a two-stage probabilistic recognition scheme that includes an acoustic model and a language model realized as a finite state directed graph data structure, where the acoustic scores from the acoustic model are utilized to compute probabilities for the different paths (or sequences of nodes and edges) of the finite state graph data structure, with the highest probability path being recognized as the desired command input by the user, for which corresponding control signals are then output by the command recognition application 240 to the appropriate onboard system 210 for implementing or executing the recognized command.

In exemplary embodiments, the processor, control module, or other hardware associated with the command system 204 executes computer-executable programming instructions that cause the command system 204 to generate, execute, or otherwise implement a vocabulary generation application 242 (or vocabulary generator) that is capable of dynamically adjusting the search space for the language model for the command recognition application 240 to reflect the current conversational context. In the illustrated embodiment, the vocabulary generation application 242 generates or otherwise constructs a keyword mapping table 250 based on analysis of the transcribed clearance communications associated with the aircraft in the clearance table 226. In this regard, entries in the keyword mapping table 250 are utilized to establish and maintain associations between parameter values identified within a transcription of a preceding audio communication and the corresponding words, terms and/or phrases that may be utilized to invoke a particular parameter value by reference. For example, based on the operational subject associated with an identified parameter value, the vocabulary generation application 242 may utilize a command vocabulary 246 to identify the potential words, terms and/or phrases that may be utilized to set or configure the parameter associated with the operational subject, and then update the keyword mapping table 250 to maintain associations between those words, terms and/or phrases and the parameter value identified from a preceding audio communication.

In the illustrated embodiment, the vocabulary generation application 242 also generates or otherwise constructs a recognition graph data structure 260 from the command vocabulary 246, where a path (or sequence of nodes and edges) of the recognition graph data structure 260 corresponds to a particular voice command to be implemented by or at an onboard system 210. In some embodiments, after a received voice command audio is probabilistically mapped or recognized to a particular path of the recognition graph data structure 260 that has the highest probability of matching the voice command audio, the vocabulary generation application 242 and/or the voice command recognition application 240 analyzes the recognized voice command using the keyword mapping table 250 to identify any words, terms and/or phrases capable of invoking a particular parameter value by reference. When the recognized voice command includes reference to an operational subject having an assigned or defined parameter value derived from a preceding audio communication, the vocabulary generation application 242 and/or the voice command recognition application 240 may augment or otherwise modify the recognized voice command to include or otherwise incorporate the mapped parameter value for the operational subject (e.g., by substituting the mapped parameter value for the reference to the operational subject).

In some embodiments, the vocabulary generation application 242 may be utilized to generate or otherwise construct a contextual recognition graph data structure 260 by utilizing the keyword mapping table 250 to add and/or remove potential paths to the contextual recognition graph data structure 260 in order to support a voice command using the words, terms and/or phrases associated with a particular operational parameter to invoke the mapped parameter value rather than requiring a fixed voice command grammar that includes the desired parameter value. In this regard, in some embodiments, the entries in the keyword mapping table 250 may be tagged with contextual information to support dynamically varying the recognition graph data structure 260 based on the current operational context of the aircraft. For example, an entry in the keyword mapping table 250 may be tagged with or otherwise maintain the flight phase, airspace and/or other operational context information at the time when the respective audio communication was received, which, in turn may be utilized by the vocabulary generation application 242 and/or the voice command recognition application 240 to limit the applicability of the entry in the keyword mapping table 250 based on the current operating context. Thus, when the aircraft changes flight phases, exits the previous airspace and/or begins operating in another airspace, and/or the like, the vocabulary generation application 242 may dynamically update the recognition graph data structure 260 to remove potential nodes, edges and/or paths that correspond to a keyword mapping that is stale or no longer relevant to the current operating context.

To generate the keyword mapping table 250, the vocabulary generator 242 analyzes the sequence of transcribed clearance communications associated with the aircraft in the clearance table 226 (e.g., using an identifier associated with the ownship aircraft) to ascertain the operational subject and corresponding operational parameter value associated with assignments received from the ATC, broadcasts received from the automatic terminal information service (ATIS), and/or requests or acknowledgments provided by the pilot. For example, communication system 208 may receive an ATIS broadcast identifying the tower frequency for the Phoenix Deer Valley airport as the frequency channel 112.1 (e.g., “DEER VALLEY TOWER INFORMATION DELTA ONE ONE TWO ONE”). The clearance table generator 222 creates a corresponding entry in the clearance table 226 that includes a transcription of the ATIS broadcast and identifies the parameter value for the airport operational subject as KDVT, the parameter value for the airport tower frequency operational subject as the frequency channel 112.1, and the ATIS broadcast as the source of the communication. Thereafter, the vocabulary generator 242 analyzes the entry for the transcribed ATIS broadcast communication in the clearance table 226 to identify frequency channel 112.1 as the assigned or defined value for the tower frequency and KDVT as the assigned or defined value for the airport. The vocabulary generator 242 creates or otherwise instantiates an entry in the keyword mapping table 250 for the 112.1 frequency channel and then utilizes the associated airport (KVDT) and source of the preceding communication (ATIS) in concert with the command vocabulary 246 to identify potential words, terms and/or phrases capable of functioning as keywords or placeholder terminology when referring to the assigned KVDT tower frequency (e.g., “Deer Valley tower,” “KVDT tower,” “ATIS tower,” “ATIS frequency,” and/or the like) to be associated with the 112.1 frequency channel entry. Additionally, the vocabulary generator 242 may tag or otherwise associate the 112.1 frequency channel entry in the keyword mapping table 250 with the KVDT terminal area and/or the airspace that the aircraft is operating in at the time of receipt of the ATIS broadcast, the current flight phase of the aircraft, and/or the like.

After creating the 112.1 frequency channel entry in the keyword mapping table 250, the pilot or other operator of the aircraft may utilize one of the potential combinations of words, terms and/or phrases when providing a voice command to set a radio frequency channel of a communications system 110 onboard the aircraft to the 112.1 frequency channel rather than orally spelling out or enunciating the desired radio frequency. In this regard, in some embodiments, the vocabulary generator 242 may dynamically determine a contextual recognition graph data structure 260 that leverages the keyword mapping table 250 to include nodes at different levels of the finite state directed graph data structure 260 that allow the pilot to use one of the words, terms and/or phrases in the keyword mapping table 250 (e.g., “tower” or “frequency”) as an alternative to spelling out the individual numerical values and decimal separator for the desired frequency. For example, the pilot may provide an oral voice command string of “Set COM1 as tower frequency” “Set COM1 as ATIS tower” or “Set COM1 as Deer Valley tower” or the like rather than “Set COM1 one one two point one.” After recognizing or otherwise resolving audio input from the microphone 206 to a particular input voice command that includes a reference to the assigned tower frequency provided by the preceding ATIS broadcast, the command system 204 and/or the voice command recognition application 240 utilizes the keyword mapping table 250 to substitute, incorporate, or otherwise include the assigned frequency channel of 112.1 in the control signals or other indicia of the recognized command input that are provided to the communications system 110, 210 to set the COM1 radio to the 112.1 frequency channel. In this manner, the communications system 110, 210 may be automatically commanded to tune the frequency of a communications radio to an assigned radio frequency channel previously communicated by ATC, ATIS, or the like using a voice command audio input that does not include the assigned radio frequency channel.

By virtue of the keyword mapping table 250, the voice command audio input provided by the pilot or other aircraft operator does not need to include the particular radio frequency channel assignment, thereby reducing the mental burden on the pilot of remembering and repeating the entire radio frequency string when providing the voice command, which may improve situational awareness. Additionally, the total number of nodes or levels of the graph data structure 260 that need to be searched to identify the received voice command may be reduced (e.g., from 5 nodes required to spell out “one one two point one” to 2 nodes for “ATIS frequency”), thereby allowing the accuracy and/or response time to be improved, which, in turn, improves the user experience and may also facilitate improved situational awareness with respect to flying the aircraft by responding more quickly and reducing delay.

As another example, the ATC may communicate for an aircraft to “Hold at waypoint GILA,” which results in the clearance table generator 222 creating a corresponding entry in the clearance table 226 that includes a transcription of the ATC clearance communication and identifies the parameter value for the next hold point operational subject as the GILA waypoint and the ATC as the source of the communication. Thereafter, the vocabulary generator 242 analyzes the entry for the transcribed ATC clearance communication in the clearance table 226 to identify GILA as the defined waypoint value for the next hold point. The vocabulary generator 242 creates or otherwise instantiates an entry in the keyword mapping table 250 for the GILA waypoint and then utilizes the source of the preceding communication (ATC) in concert with the command vocabulary 246 to identify potential words, terms and/or phrases capable of functioning as keywords or placeholder terminology when referring to the waypoint specified by ATC (e.g., “ATC cleared waypoint,” “ATC hold waypoint,” and/or the like) to be associated with the GILA waypoint entry.

Thereafter, the pilot or other operator of the aircraft may utilize one of the potential placeholder terminology when providing a voice command to configure the FMS 114 or other onboard system 210 to insert a hold within the flight plan at the GILA waypoint rather than articulating or enunciating the specified waypoint. For example, the pilot may provide an oral voice command string of “Hold at ATC cleared waypoint,” which may be recognized as including a reference to the designated waypoint provided by a preceding ATC clearance communication. The command system 204 and/or the voice command recognition application 240 utilizes the keyword mapping table 250 to designate, incorporate, or otherwise include the GILA waypoint in the control signals or other indicia of the recognized command input that are provided to the FMS 114 and/or other onboard system 210 to insert a temporary hold at the GILA waypoint. In this manner, the FMS 114 and/or other onboard system 210 may be automatically commanded to set a waypoint or other navigational reference point to a particular name or identifier from an assignment previously communicated by ATC, ATIS, or the like (e.g., by updating or modifying a flight plan to include or otherwise traverse the designated waypoint) using a voice command audio input that does not include the assigned waypoint name or identifier.

It should be noted that FIG. 2 is a simplified representation of the speech recognition system 200 and is not intended to be limiting. It should be noted that although some implementations of the subject matter are described in the context of the keyword mapping table 250 being generated by the vocabulary generation application 242 of the command system 204, in other implementations, the keyword mapping table 250 may be generated by the clearance table generator 222 in connection with generating the clearance table 226. In this regard, although FIG. 2 depicts the keyword mapping table 250 and the clearance table 226 as distinct or separate components, in practice, the keyword mapping table 250 may be integrated into the clearance table 226 or otherwise implemented in concert with the clearance table 226 at a common data storage element 224. Additionally, the subject matter described herein is not limited to any particular operational parameter or onboard system. In practice, the subject matter described herein may be utilized to automatically command any sort of avionics system or onboard vehicle system to implement a specific parameter value derived from a transcription of a preceding audio communication with respect to the vehicle in response to receiving and recognizing voice command audio input that does not include the specific parameter value, but rather indicates intent to incorporate the specific parameter value by reference by implicating an operational subject or entity that corresponds to, maps to or is otherwise associated with the operational subject or entity associated with the specific parameter value.

FIG. 3 depicts an exemplary embodiment of a contextual mapping process 300 suitable for implementation by an aircraft system to resolve or otherwise recognize a voice command or other received audio using the preceding conversational context to map keywords or placeholder terminology to a previously communicated parameter value. The various tasks performed in connection with the illustrated process may be implemented using hardware, firmware, software executed by processing circuitry, or any combination thereof. For illustrative purposes, the following description may refer to elements mentioned above in connection with FIGS. 1-2. In practice, portions of the contextual mapping process 300 may be performed by different elements of the aircraft system 100. That said, exemplary embodiments are described herein in the context of the contextual mapping process 300 being primarily performed by the processing system 106 implementing a contextual speech recognition system 200. It should be appreciated that the contextual mapping process 300 may include any number of additional or alternative tasks, the tasks need not be performed in the illustrated order and/or the tasks may be performed concurrently, and/or the contextual mapping process 300 may be incorporated into a more comprehensive procedure or process having additional functionality not described in detail herein. Moreover, one or more of the tasks shown and described in the context of FIG. 3 could be omitted from a practical embodiment of the contextual mapping process 300 as long as the intended overall functionality remains intact.

Referring to FIG. 3 with continued reference to FIGS. 1-2, in exemplary embodiments, the contextual mapping process 300 continually monitors and analyzes received audio communications and automatically identifies or otherwise extracts values that have been assigned, defined, or otherwise designated for particular operational parameters based on the content of the received audio communications (task 302). As described above, in exemplary embodiments, the audio content of clearance communications received at the aircraft is continually transcribed into corresponding textual representations, which, in turn, are then parsed and analyzed to identify the operational subjects and parameters specified within the received sequence of clearance communications pertaining to the aircraft. For example, natural language processing may be applied to the textual representations of the clearance communications directed to the ownship aircraft by ATC, provided by the ownship aircraft to ATC, or received from ATIS to identify the operational subject(s) of the clearance communications and any operational parameter value(s) and/or aircraft action(s) associated with the clearance communications.

After identifying assigned, defined, or otherwise designated values for a particular operational parameter, the contextual mapping process 300 automatically establishes or otherwise creates one or more mappings between keywords or placeholder terminology that may be utilized to invoke or incorporate that operational parameter value by reference (task 304). For example, as described above, based on the identified operational parameter and/or the operational subject associated therewith, a command vocabulary 246 may be analyzed to select or otherwise identify a subset of potential words, terms and/or phrases that may be utilized as a keyword or placeholder for the parameter value. An entry in a keyword mapping table 250 is then created to maintain an association between the operational parameter value derived from the preceding audio communication(s) or conversational context and the potential keywords or placeholder terms that are likely to be used by a pilot or other operator to reference that parameter.

After establishing keyword mappings for an operational parameter value, the contextual mapping process 300 continues by recognizing received voice command audio as including a keyword or other placeholder terminology that is mapped to that operational parameter value and automatically augmenting or otherwise modifying the recognized voice command to include the operational parameter value derived from preceding audio communication(s) based on the mapping before providing output signals corresponding to the augmented recognized command to the appropriate onboard system(s) (tasks 306, 308, 310). For example, when a pilot manipulates the user input device 104 to indicate a desire to provide a voice command or otherwise initiate provisioning a voice command, the command system 204 and/or the command recognition application 240 resolves or otherwise recognizes the voice command audio subsequently received via the microphone 206 to a particular path of the recognition graph data structure 260. Once the voice command audio is probabilistically mapped or recognized to a particular path of the recognition graph data structure 260 having the highest probability of matching the voice command audio (e.g., using speech-to-text recognition), the voice command recognition application 240 may utilize the keyword mapping table 250 to scan or otherwise analyze the content of the recognized voice command to identify any keywords or placeholders within the recognized voice command that have been mapped to a particular operational parameter value.

When the voice command recognition application 240 identifies placeholder terminology that corresponds to an established keyword mapping for a predefined operational parameter value derived from a preceding audio communication, voice command recognition application 240 may automatically augment or otherwise modify the recognized voice command to include that operational parameter value as a commanded parameter value to be associated with the voice command in lieu of or in addition to the placeholder terminology. Thereafter, the voice command recognition application 240 may map, translate, or otherwise convert the augmented recognized voice command including the operational parameter value derived from a preceding audio communication into a corresponding command for one or more destination onboard system(s) 210 to implement or otherwise execute the commanded operational parameter value derived from the preceding audio communication. In this manner, a pilot or other vehicle operator may use keywords or placeholder terminology in voice commands to provide a previously communicated parameter value as a commanded value to an onboard system 210 without having to articulate, enunciate or even remember the exact value for the operational parameter that was previously communicated.

For example, in one embodiment, a template-based pattern matching approach (or template matching) is utilized to identify sets of keywords or key values that may be utilized to establish mappings using the format or syntax of commands supported by the command vocabulary 246. In this regard, natural language processing and template matching may be applied to historical ATC conversations and corresponding pilot inputs or actions or other reference data to derive key value pairs using pattern matching by tagging parts of speech. or example, for a reference voice command of “HOLD AT WAYPOINT AFRIC,” natural language processing may identify the intent of the command is to hold at waypoint AFRIC, where the word “HOLD” is tagged or matched to the action word in the command, “WAYPOINT” is tagged or matched to the operational subject of the command (e.g., the place where the hold action applies), and “AFRIC” is tagged or matched to the operational parameter value (e.g., the waypoint identifier) for the operational subject of the command (e.g., the name of the place where the hold action applies). Thereafter, when received voice command audio contains the phrase “HOLD AT ATC WAYPOINT,” the contextual mapping process 300 identifies the term “ATC WAYPOINT” as a placeholder for the waypoint identifier for the subject waypoint of the hold action. Natural language processing or the like may be performed on the placeholder terminology (e.g., “ATC WAYPOINT”) to identify that the value should be mapped from a preceding communication from the ATC, and based thereon, the contextual mapping process 300 may identify the specified value for the waypoint identifier (e.g., AFRIC) from the transcription of a preceding communication from the ATC and then augment the received voice command to include the specified value for the waypoint identifier in lieu of the placeholder terminology (e.g., “HOLD AT AFRIC”). Thereafter, the voice command recognition application 240 may generate a corresponding command for implementing the hold action at the specified waypoint (e.g., AFRIC) and provide the command to one or more destination onboard system(s) 210 to implement or otherwise execute the hold action using the waypoint identifier derived from a transcription of a preceding ATC audio communication.

In practice, the contextual mapping process 300 may repeat throughout operation to dynamically update the keyword mappings to reflect more recent audio communications or changes to the operating context. For example, when the aircraft exits the KVDT airspace or terminal area, the vocabulary generation application 242 may dynamically update the keyword mapping table 250 to remove or inactivate the KVDT tower frequency entry for invoking the 112.1 frequency channel based on the difference between the current aircraft operating context and the operating context associated with the 112.1 frequency channel entry. In a similar manner, when a more recent communication is received that includes a different tower frequency that conflicts with an existing or previous entry in the keyword mapping table 250, the vocabulary generation application 242 may dynamically update the keyword mapping table 250 to remove or inactivate that existing entry in concert with creating a new entry in the keyword mapping table 250 that reflects the more recently communicated tower frequency.

Referring to FIGS. 2-3, in one or more exemplary embodiments, the keyword mapping table 250 is configured as a one-hot decoder (or decoding table) configured to work in concert with the command and control decoding performed by the command recognition application 240 using the recognition graph data structure 260. For example, the clearance table generator 222 and/or the vocabulary generator 242 may perform natural language processing on the transcribed text of the received audio communications to identify the operational subjects or entities within a respective audio communication (e.g., a waypoint, a call sign, an airport, a flight name, and/or the like) and the parameter values defined or otherwise assigned to those operational subjects. For defined operational parameter value within a respective audio communication, clearance table generator 222 and/or the vocabulary generator 242 creates a corresponding entry in the keyword mapping table 250 that is configured to support one-hot decoding by maintaining the defined operational parameter value in association with the operational subject to which it pertains, the source of the respective audio communication from which the parameter value was derived, and the current operational context of the aircraft at the time of receipt of the respective audio communication (e.g., the current flight phase, the current airspace or geographic region of operation, the current aircraft configuration, the current aircraft altitude, and/or the like). The command recognition graph data structure 260 and/or the command vocabulary 246 may be correspondingly configured to support recognition of voice commands that include reference to a particular operational subject, parameter, or other entity using intuitive voice commands within the current conversational context rather than specifying a defined operational parameter value. In this regard, rather than the command recognition graph data structure 260 and/or the command vocabulary 246 being configured for specific value decoding using a more constrained acoustic and/or language model, the command recognition application 240 may support more generic keyword decoding using a less constrained acoustic and/or language model.

When the command recognition application 240 recognizes a voice command that includes a generic keyword rather than a specific value, the command recognition application 240 may then query the one-hot decoding supported by the keyword mapping table 250 to obtain the particular operational parameter value that has been previously defined, assigned or otherwise designated for that particular keyword and thereby utilize the keyword mapping table 250 to augment the voice command to include or otherwise incorporate that specific operational parameter value derived from a preceding audio communication. In this regard, the command recognition graph data structure 260 and/or the command vocabulary 246 may be configured to achieve a faster response time and/or higher accuracy using more generic keywords or placeholders rather than being constrained to commands that require orally spelling out specific parameter values. Rather than requiring acoustic or language models that are pretrained or otherwise preconfigured to map different keywords, placeholder terms, or other indirect references to specific values, which could increase the size of the models and recognition graphs and undesirably delay response time, the one-hot decoding using the keyword mapping table 250 allows the command recognition graph data structure 260 and/or the command vocabulary 246 to be designed to merely recognize simpler voice commands, which can then be augmented and mapped to specific values by querying the keyword mapping table 250 that is dynamically varied or adapted in real-time to reflect the current operating context and current conversational context.

To briefly summarize, by utilizing multiple speech engines (e.g., clearance transcription and command recognition) and leveraging the current context of the ATC clearance communications to establish mappings between previously communicated parameter values and potential keywords or placeholder terminology that may be utilized to refer to those parameter values, a pilot or other aircraft operator can more conveniently command onboard systems to effectuate the previously communicated parameter values using voice commands without having to remember or enunciate the exact values. This improves the user experience while also reducing workload, thereby improving situational awareness. Additionally, leveraging keywords or placeholders rather than relying on longer strings of numerical values, decimal separators and/or the like may also reduce response time and improving accuracy, thereby further improving the user experience and usability.

For the sake of brevity, conventional techniques related to user interfaces, speech recognition, avionics systems, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method of assisting operation of a vehicle, the method comprising:
automatically identifying a parameter value for an operational subject based at least in part on an audio communication with respect to the vehicle;
recognizing an audio input as an input command;
determining a second operational subject associated with the input command; and
automatically commanding a vehicle system associated with the operational subject to implement the parameter value when the second operational subject corresponds to the operational subject.

2. The method of claim 1, further comprising transcribing the audio communication to obtain a transcription of the audio communication, wherein automatically identifying the parameter value comprises automatically identifying the parameter value within the transcription of the audio communication.

3. The method of claim 2, wherein automatically identifying the parameter value within the transcription of the audio communication comprises automatically identifying the parameter value within the transcription of a preceding audio communication prior to receiving the audio input from an audio input device onboard the vehicle.

4. The method of claim 3, wherein the preceding audio communication comprises an air traffic control (ATC) clearance or an automatic terminal information service (ATIS) broadcast.

5. The method of claim 1, wherein automatically identifying the parameter value comprises automatically identifying the parameter value prior to receiving the audio input from an audio input device onboard the vehicle.

6. The method of claim 5, wherein the audio communication comprises an air traffic control (ATC) clearance or an automatic terminal information service (ATIS) broadcast.

7. The method of claim 1, wherein:
determining the second operational subject associated with the input command comprises identifying placeholder terminology within the input command; and
automatically commanding the vehicle system comprises automatically commanding the vehicle system to implement the parameter value based on an association between the placeholder terminology and the operational subject associated with the parameter value.

8. The method of claim 7, further comprising creating an entry in a table maintaining an association between the parameter value and the operational subject prior to receiving the audio input, wherein automatically commanding the vehicle system comprises:
querying the table using placeholder terminology to obtain the parameter value from the entry; and
automatically commanding the vehicle system to implement the parameter value obtained by querying the table using the placeholder terminology.

9. The method of claim 1, wherein the audio input does not include the parameter value.

10. The method of claim 1, wherein:
the parameter value for the operational subject comprises an assigned frequency for a communications radio;
the input command comprises setting a frequency of the communications radio; and
automatically commanding the vehicle system comprises automatically commanding a communications system to tune the frequency of the communications radio to the assigned frequency.

11. The method of claim 10, wherein the audio input does not include the assigned frequency.

12. The method of claim 11, wherein determining the second operational subject comprises determining the input command pertains to the communications radio.

13. The method of claim 1, wherein:
the operational subject comprises at least one of a navigational reference point or an onboard system;
the parameter value comprises an assignment for the operational subject;
the input command comprises setting a value for the at least one of the navigational reference point or the onboard system; and
automatically commanding the vehicle system comprises automatically commanding the vehicle system to set the value for the at least one of the navigational reference point or the onboard system to an updated value corresponding to the assignment.

14. The method of claim 13, wherein the audio input does not include the assignment for the operational subject.

15. A computer-readable medium having computer-executable instructions stored thereon that, when executed by a processing system, cause the processing system to:
automatically identify a parameter value for an operational subject based at least in part on a preceding audio communication with respect to a vehicle prior to receiving voice command audio input;
recognize the voice command audio input as an input command including placeholder terminology; and
automatically command a vehicle system to implement the input command utilizing the parameter value when the placeholder terminology corresponds to the operational subject.

16. The computer-readable medium of claim 15, wherein the computer-executable instructions cause the processing system to:
augment the input command to incorporate the parameter value, resulting in an augmented input command; and
automatically command the vehicle system by outputting command signals corresponding to the augmented input command.

17. The computer-readable medium of claim 15, wherein the computer-executable instructions cause the processing system to:
obtain a transcription of the preceding audio communication; and
automatically identify the parameter value within the transcription of the preceding audio communication.

18. The computer-readable medium of claim 15, wherein:
the preceding audio communication comprises an air traffic control (ATC) clearance or an automatic terminal information service (ATIS) broadcast; and
the parameter value comprises an assignment for the operational subject.

19. The computer-readable medium of claim 18, wherein the input command includes the placeholder terminology in lieu of the assignment for the operational subject.

20. A system comprising:
a communications system to receive an audio communication with respect to a vehicle;
an audio input device receive input voice command audio; and
a processing system coupled to the communications system and the audio input device to:
automatically identify a parameter value for an operational subject based at least in part on the audio communication prior to receiving the input voice command audio;
recognize the input voice command audio as an input command including placeholder terminology; and
automatically command a vehicle system to implement the input command using the parameter value when the placeholder terminology corresponds to the operational subject.
